(19) United States
(12) Patent Application Publication
(10) Pub. No.: US 2009/0092179 A1
(43) Pub. Date: Apr. 9, 2009

(54) Method and a circuit for estimating the signal quality of a communication channel and a wireless receiving apparatus using the same

(76) Inventors: Chi-Tung Chang, Taipei (TW); Chun-Yi Wu, Taipei (TW); Yu-Ling Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/987,028

(22) Filed: Nov. 27, 2007

(30) Foreign Application Priority Data
Oct. 3, 2007 (TW) 96137041

(51) Int. Cl. H04Q 1/20

(52) U.S. Cl. 375/227; 375/E01.02

(57) ABSTRACT

A method for estimating the signal quality of a communication channel is disclosed. Firstly, an input signal passes through a match filter at the initial stage of an estimation period. Next, the output of the match filter is calculated to obtain the noise reference value within a pre-determined period. The output value of the match filter and the noise reference value are compared. When the output value of the match filter is larger than the noise reference value, a valid power value is obtained according to the output value of the match filter. The valid power values are accumulated. Finally, a SNR is calculated according to the noise reference value and the accumulated valid power value at the end of the estimation period. Thereby, the signal quality of the wireless communication channel is estimated according to the SNR, and the signal transmission rate is determined.

### BACKGROUND OF THE INVENTION

1. Field of the Invention

The present invention relates to a wireless receiving apparatus. In particular, this invention relates to a circuit and a method for estimating the signal quality of a communication channel of the wireless receiving apparatus.

2. Description of the Related Art

The communication area can be extended by the wireless local internet cooperating with the wired internet. Because Ultra Wide Band (UWB) technology has a high speed transmission rate, UWB technology is popularly applied to the consumer electronic industry and the information technology industry. The UWB system has a plurality of communication channels. The receiver includes a lot of key technology, such as band detection, packet detection, frame boundary estimation, timing offset estimation, compensation estimation and channel estimation, and a Viterbi decoder to enhance the system performance.

The signal quality of the communication channel is a key index to determine the transmission signal flux. There are two methods to estimate the signal quality of the wireless receiving apparatus. The first method is to detect the survival metric of the signal that has been produced by the Viterbi decoder. The second method is to detect the peak value of the output of the match filter to evaluate the signal attenuations affected by the channel noise.

The first method has following disadvantages. When the signal-to-noise ratio (SNR) is too low to exceed the decoding ability of the Viterbi decoder, the related survival metric is inaccurate. Due to this drawback, the signal quality value cannot be properly applied to adjust the transmission rate. In the prior art, a lower transmission rate is used to launch the communication. After the communication is verified, the transmission rate is gradually increased and then we can get a proper transmission rate after a period of long time. But this method will waste most of channel bandwidths.

Reference is made to FIG. 1, which shows a schematic diagram of the system structure of the signal quality estimating circuit of the prior art. The second signal quality estimation method is illustrated. The signal quality estimation circuit 10 includes a match filter 120, and a comparing unit 130. The match filter 120 utilizes the unique preamble of the communication channel to perform a matching calculation with the input signal. When the input signal matches the preamble, the output of the match filter reaches to a peak value. The comparing unit 130 coupled with the match filter 120 detects the peak value of the output of the match filter 120. After that, the system determines the signal transmission rate according to the peak value.

However, the output peak detection technology for the match filter merely can be applied to the additive white Gaussian noise (AWGN) channel model. It cannot be applied to a multi-path channel model because the attenuation effect of the multi-path channel makes the output of the match filter 120 have a great amount of variation. A lot of local maximum peak values are outputted and the correct signal quality cannot be obtained due to the multi-path delay effect occurs in the wireless communication system.

### SUMMARY OF THE INVENTION

One particular aspect of the present invention is to provide a circuit and a method for estimating the signal quality of a communication channel for a wireless receiving apparatus. Firstly, a noise reference value is obtained. Next, a valid power value is obtained according to the noise reference value, and the signal-to-noise ratio is calculated. The signal quality of the wireless communication channel is correctly and rapidly estimated to increase the transmission flux even if the communication channel suffers from heavy channel noise or has a multi-path attenuation.

The method for estimating the signal quality of a communication channel is suitable for estimating the wireless communication quality. Firstly, an input signal passes through a match filter at the initial stage of an estimation period. Next, the output of the match filter is calculated to obtain the noise reference value within a pre-determined period. The output value of the match filter and the noise reference value are compared. When the output value of the match filter is larger than the noise reference value, a valid power value is obtained according to the output value of the match filter. The valid power values are accumulated. Finally, a SNR is calculated according to the noise reference value and the accumulated valid power value at the end of the estimation period. Thereby, the signal quality of the wireless communication channel is estimated according to the SNR.

The circuit for estimating the signal quality of a communication channel includes a match filter, a noise power calculating unit, a signal/noise power comparing unit, a signal power calculating unit, and a SNR calculating unit. The match filter receives an input signal to perform a matching calculation and outputs the result within an estimation period. The noise power calculating unit calculates the output value of the match filter to obtain a noise reference value within a pre-determined period. The signal/noise power comparing unit compares the output value of the match filter and the noise reference value, and obtains a valid power value according to the output value of the match filter when the output value of the match filter is larger than the noise reference value. The signal power calculating unit accumulates the valid power values. The SNR calculating unit receives and calculates the noise reference value and the accumulated valid power value to obtain a SNR.

The present invention also provides a wireless receiving apparatus having the circuit for estimating the signal quality of a communication channel. The wireless receiving apparatus determines the signal transmission rate according to the SNR.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the system structure of the signal quality estimating circuit of the prior art;

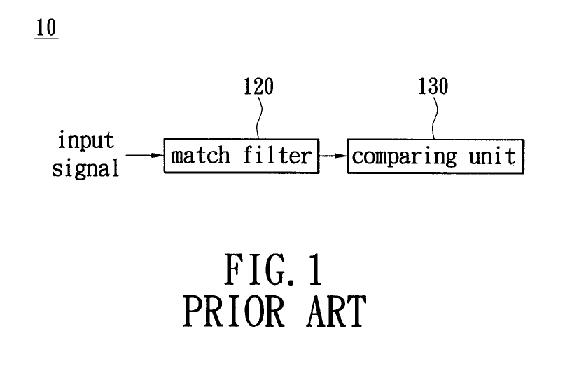

FIG. 2 is a schematic diagram of the system structure of the signal quality estimating circuit of the present invention;

FIG. 3 is a schematic diagram of the circuit of the match filter;

FIG. 4 is a waveform diagram of the output signal of the match filter in multi-path channels; and

FIG. 5 is a flow chart of the method for estimating the signal quality of a communication channel of the present invention.

### DETAILED DESCRIPTION OF THE PREFERRED EMBODIMENTS

The circuit and the method for estimating the signal quality of a communication channel of the present invention is applied to the wireless receiving apparatus with the ultra wide band (UWB) technology, and use a calculation algorithm to obtain the signal-to-noise ratios. Even though the channel noise is heavy or the multi-path attenuation exists, the signal quality of the communication channel can be correctly and easily estimated, and the transmission flux is increased.

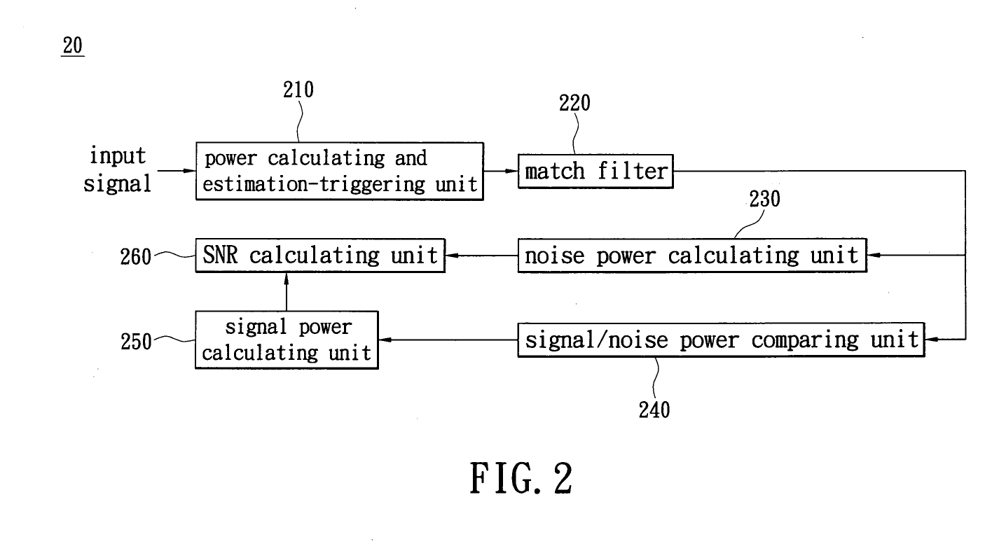

Reference is made to FIG. 2, which shows a schematic diagram of the system structure of the signal quality estimating circuit 20 of the present invention. The signal quality estimating circuit 20 is located in a wireless receiving apparatus for calculating the SNR of the communication channel. Next, the transmission rate of the communication system is determined according to the SNR.

As shown in FIG. 2, the signal quality estimating circuit 20 includes a power calculating and estimation-triggering unit 210, a match filter 220, a noise power calculating unit 230, a signal/noise power comparing unit 240, a signal power calculating unit 250, and a SNR calculating unit 260. Except for the power calculating and estimation-triggering unit 210, the other units (220˜260) usually are in a standby status. The power calculating and estimation-triggering unit 21 is coupled with the input terminal of the match filter 220 for calculating the power of the input signal. When the power of the input signal is larger than a threshold value, this means that the packet is detected. At this time, the power calculating and estimation-triggering unit 210 triggers the start of the signal quality estimation period and starts the other units (220˜260).

During the signal quality estimation period, the match filter 220 receives the input signals to perform a matching calculation and outputs the result. The noise power calculating unit 230 is coupled with the match filter 220 for calculating the output value of the match filter 220 to obtain a noise reference value within a pre-determined period after the signal quality estimation period is started. The signal/noise power comparing unit 240 is coupled with the match filter 220 for comparing the output value of the match filter 220 and the noise reference value, and obtaining a valid power value according to the output value of the match filter 220 when the output value of the match filter 220 is larger than the noise reference value. The signal power calculating unit 250 is coupled with the signal/noise power comparing unit 240 for accumulating the valid power values. The SNR calculating unit 260 is coupled with the noise power calculating unit 230 and the signal power calculating unit 250 for receiving and calculating the noise reference value and the accumulated valid power value to obtain a SNR. Thereby, the wireless receiving apparatus uses the SNR to determine the packet transmission rate.

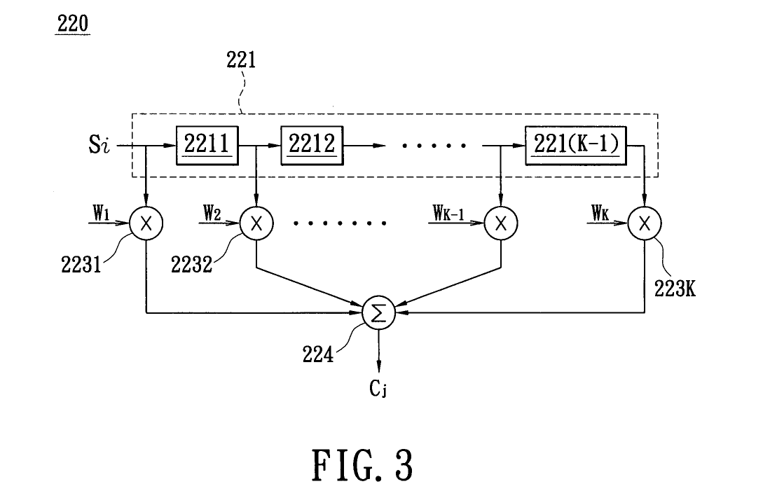

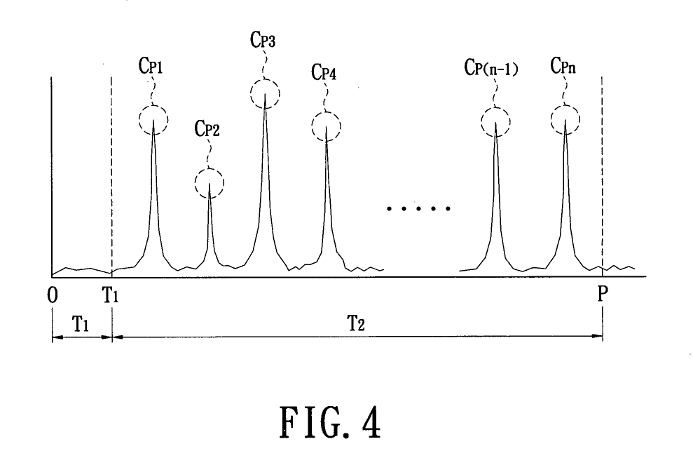

The following processes are used for illustrating the concept of the present invention. Reference is made to FIGS. 2, 3 and 4. FIG. 3 is a schematic diagram of the circuit of the match filter 220. FIG. 4 is a waveform diagram of the output signal of the match filter 220 in Multi-path channels. The X-coordination is the sampling time. The Y-coordination is the amplitude of the output signal of the match filter 220. Period 0˜P is the signal quality estimation period. Period 0˜T1 (T1 period) is the predetermined period. Period T1˜P (T2 period) is the valid power calculation period.

Firstly, the default input signal is Si. The power calculating and estimation-triggering unit 210 uses the formula 1 to calculate the power of the input signal Si.

$${\sum }_{i = 0}^{N - 1} {\vert {S}_{i} \vert}^{2} \qquad ( formula 1 )$$

N is the number of signal samples within the pre-determined period.

When the calculating result of the formula 1 is larger than a threshold value, the power calculating and estimation-triggering unit 210 triggers the start of the signal quality estimation period and starts the other units, such as the match filter 220, etc. The threshold value is the experimental value of the hardware.

As shown in FIG. 3, the match filter 220 is composed of the shift register 221, the multipliers 2231˜223K, and the adder 224. The shift register 221 includes (K−1) flip-flops 2211˜221(K−1) that are connected in serial. K is the data length of the preamble of the match filter 220. The input signal Si enters into the shift register 221 and passes through the flip-flops 2211˜221(K−1) in order. Next, the input signal Si uses the multipliers 2231˜223K to multiply with the preambles W1˜WK. The calculating results of the multipliers 2231˜223K are added together by the adder 224 and outputted. The output value Cj is obtained by formula 2.

$${C}_{j} = {\sum }_{i = 1}^{K} ( {S}_{i + j} \cdot {W}_{i} ) \qquad ( formula 2 )$$

j is the sampling index within pre-determined period T1 of the match filter 220.

Because the output value of the match filter 220 is the background noise in the first stage, a pre-determined period T1 is set. The noise power calculating unit 230 accumulates the output value of the match filter 220 during the pre-determined period T1, and calculates the average value of the accumulated output value of the match filter 220 when the pre-determined period T1 ends. This means that the accumulated output value of the match filter 220 is divided by the sampling number. The calculating result is defined as a noise reference value Enoise, and is used as a reference value to evaluate the background noise. The calculating formula for the noise reference value Enoise is as formula 3.

$${E}_{noise} = mean [ {\sum }_{{T}_{1}} ( {\sum }_{i = 1}^{K} ( {S}_{i + j} \cdot {W}_{i} ) ) ] , 0 \leq j \leq {T}_{1} \qquad ( formula 3 )$$

The present invention defines the output value of the match filter 220 that is larger than the noise reference value Enoise as the valid power value Esgn. Next, during the period T2, the signal/noise power comparing unit 240 compares the output value of the match filter 220 and the noise reference value Enoise. When the output value Cj of the match filter 220 is larger than the noise reference value Enoise (such as the peak values CP1˜CPn in FIG. 4), a valid power value Esgn is obtained according to the output value of the match filter 220.

In one embodiment, the valid power value Esgn is equal to the output value of the match filter 220 (Esgn=Cj, Cj>Enoise). In a second embodiment, the valid power value Esgn is equal to the output value of the match filter 220 minus the noise reference value Enoise (Esgn=Cj−Enoise, Cj>Enoise). The calculating result of the second embodiment is more accurate than the first embodiment.

During the valid power calculation period T2, the signal power calculating unit 250 accumulates all the valid power values Esgn. Thereby, the signal power can be exactly estimated even though the channel noise and the multi-path attenuation exist. The accumulated valid power values Esgn′ is obtained by formula 4.

$${E}_{sgn}^{′} = {\sum }_{{T}_{2}} {E}_{sgn} \qquad ( formula 4 )$$

When the signal quality estimation period ends, the SNR calculating unit 260 performs a calculation to the noise reference value Enoise and the accumulated valid power values Esgn′ to obtain a SNR. The calculation formula is formula 5.

$$SNR = \frac{{E}_{sgn}^{′}}{{E}_{noise}^{2}} \qquad ( formula 5 )$$

By using above processes, the signal quality of the communication channel is correctly estimated even though the channel noise and the multi-path attenuation exist.

Furthermore, the signal quality estimating circuit 20 can be realized in the communication module for fitting within the UWB communication chip. The communication chip means that the control core (such as microprocessor), the memory, and the logic circuit are manufactured as one or more than one integrated circuit chips. The control core uses the planned firmware to control the hardware to perform the communication operation. All units (210˜260) of the signal quality estimating circuit 20 can be implemented, by digital signal processing technology, and are controlled by the control core according to the timings of the signal quality estimation period to obtain the required values. Finally, the SNR is obtained and is outputted to the high-layer control core to determine the signal transmission rate and control the other algorithm to perform the communication operation.

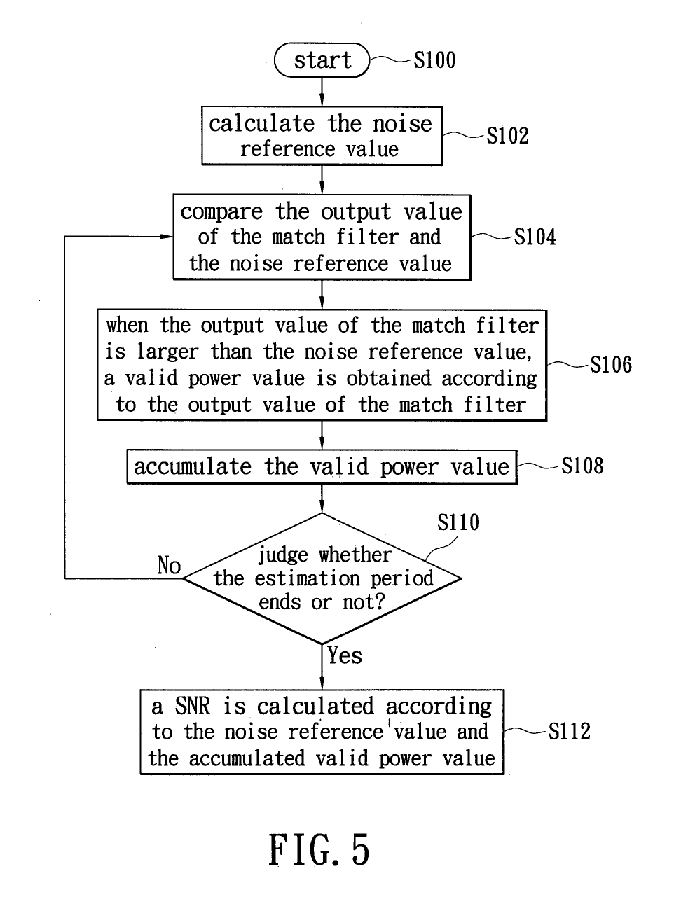

The present invention also provides a method for estimating the signal quality of a communication channel. Reference is made to FIG. 5, which shows a flow chart of the method for estimating the signal quality of a communication channel of the present invention. The related system structure is shown in FIG. 2. The method for estimating the signal quality of a communication channel includes the following steps.

Firstly, the power calculating and estimation-triggering unit 21 calculates the power of the input signal, and triggers the start of the signal quality estimation period when the power of the input signal is larger than a threshold value, and the match filter 220 is started to accept the input signal (S100).

During the pre-determined period, the noise power calculating unit 230 performs a calculation operation to the output value of the match filter 220 to obtain a noise reference value (S102).

Next, the signal/noise power comparing unit 240 compares the output value of the match filter 220 and the noise reference value (S104).

When the output value of the match filter 220 is larger than the noise reference value, the signal power calculating unit 250 obtains a valid power value obtained according to the output value of the match filter 220 (S106).

The signal power calculating unit 250 accumulates the valid power values (S108).

Whether the signal quality estimation period ends or not is judged (S110).

When the signal quality estimation period does not end, the step S104 is repeated.

When the signal quality estimation period ends, the SNR calculating unit 260 performs a calculation operation to the noise reference value and the accumulated valid power value to obtain the SNR (S112).

Thereby, the processing algorithm at the rear stage determines the signal transmission rate according to the SNR.

By referring to above embodiment, the circuit for estimating the signal quality of a communication channel and the method thereof use the noise reference value to obtain the valid power value which is used to evaluate the effect of signal power when the background noise exists, and then the SNR can be calculated. The signal quality of the communication channel is correctly and rapidly estimated and is used to determine an optimum signal transmission rate to perform a wireless communication even though the communication channel has a heavy channel noise or a multi-path attenuation.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A method for estimating the signal quality of a communication channel, comprising:
accepting an input signal to pass through a match filter at the initial stage of an estimation period;
calculating the output of the match filter to obtain a noise reference value within a pre-determined period;
comparing the output value of the match filter and the noise reference value, wherein a valid power value is obtained according to the output value of the match filter when the output value of the match filter is larger than the noise reference value;
accumulating the valid power values; and
calculating a signal-to-noise ratio (SNR) according to the noise reference value and the accumulated valid power value at the end of the estimation period;
thereby the signal quality of the wireless communication channel is estimated according to the SNR.

2. The method for estimating the signal quality of a communication channel as claimed in claim 1, further comprising:
calculating the power of the input signal; and
triggering the start of the estimation period when the power of the input signal is larger than a threshold value.

3. The method for estimating the signal quality of a communication channel as claimed in claim 1, wherein the noise reference value is the average value of the accumulated output value of the match filter within the pre-determined period.

4. The method for estimating the signal quality of a communication channel as claimed in claim 1, wherein the valid power value is equal to the output value of the match filter minus the noise reference value.

5. The method for estimating the signal quality of a communication channel as claimed in claim 1, wherein the valid power value is equal to the output value of the match filter.

6. The method for estimating the signal quality of a communication channel as claimed in claim 1, wherein the SNR is the quotient of the accumulated valid power value divided by the square of the noise reference value.

7. A circuit for estimating the signal quality of a communication channel, comprising:
a match filter receiving an input signal to perform a matching calculation and output the result within an estimation period;
a noise power calculating unit calculating the output value of the match filter to obtain a noise reference value within a pre-determined period;
a signal/noise power comparing unit comparing the output value of the match filter and the noise reference value, wherein a valid power value is obtained according to the output value of the match filter when the output value of the match filter is larger than the noise reference value;
a signal power calculating unit accumulating the valid power values; and
a SNR calculating unit receiving and calculating the noise reference value and the accumulated valid power value to obtain a SNR.

8. The circuit for estimating the signal quality of a communication channel as claimed in claim 7, further comprising a power calculating and estimation-triggering unit, wherein the power calculating and estimation-triggering unit calculates the power of the input signal, triggers the start of the estimation period and starts the match filter to receive the input signal when the power of the input signal is larger than a threshold value.

9. The circuit for estimating the signal quality of a communication channel as claimed in claim 7, wherein the noise reference value is the average value of the accumulated output value of the match filter within the pre-determined period.

10. The circuit for estimating the signal quality of a communication channel as claimed in claim 7, wherein the valid power value is equal to the output value of the match filter minus the noise reference value.

11. The circuit for estimating the signal quality of a communication channel as claimed in claim 7, wherein the valid power value is equal to the output value of the match filter.

12. The circuit for estimating the signal quality of a communication channel as claimed in claim 7, wherein the SNR is the quotient of the accumulated valid power value divided by the square of the noise reference value.

13. A wireless receiving apparatus having the circuit for estimating the signal quality of a communication channel as claimed in claim 7, wherein the wireless receiving apparatus determines the signal transmission rate according to the SNR.
